(19) United States
(12) Patent Application Publication
(10) Pub. No.: US 2019/0247809 A1
(43) Pub. Date: Aug. 15, 2019

(54) Portable Dosing System and Method of Use

(71) Applicant: William Jeffery Shackelford, Olive Branch, MS (US)

(72) Inventor: William Jeffery Shackelford, Olive Branch, MS (US)

(21) Appl. No.: 14/851,918

(22) Filed: Sep. 11, 2015

(51) Int. Cl. B01F 5/10; B01F 15/00

(52) U.S. Cl. CPC B01F 5/10; B01F 15/00357; B01F 15/00363

(57) ABSTRACT

A portable dosing system used for the transfer of liquid and slurries from a feed container to a mix container that monitors the amount transferred by measuring the change in pressure within the feed container.

### CROSS-REFERENCE TO RELATED APPLICATIONS

Not Applicable

### STATEMENT REGARDING FEDERALLY SPONSORED RESEARCH OR DEVELOPMENT

Not Applicable

### Reference to Sequence Listing, a Table, or a Computer Program Listing Compact Disc

Not Applicable

### FIELD OF THE INVENTION

This disclosure relates to a portable dosing system for transferring measured amounts of liquid from a feed container to a mix container wherein the amount of liquid measured out is done so through the use of a change in pressure of the liquid in the feed container.

### BACKGROUND OF THE INVENTION

Portable dosing system are known in the art to use changes in the overall mass of a feed container or measurement of the volume of liquid transferred from a feed container to ensure proper amounts of liquid are transferred from a feed container to a mix container. The present disclosure is distinct from the state of the art in that it uses the change in pressure of the liquid contained in the feed container to determine when an appropriate amount of liquid has been transferred out. Also revealed are methods of operation and calibration of the portable dosing system.

### SUMMARY OF THE INVENTION

The present disclosure reveals a portable dosing system used to transfer a liquid from a feed container to a mix container and identifies when the appropriate amount of liquid has been transferred through change in pressure within the feed container.

In the first embodiment, the portable dosing system monitors the change in pressure within the feed container in order to allow the identification of when the appropriate amount of liquid has been transferred to the feed container. In the second embodiment, the portable dosing system uses a pressure transmitter in combination with the depth of the liquid to be transferred and the internal dimensions of the feed tank to calculate the specific gravity of the liquid to be transferred in order to then determine the appropriate change in pressure required to transfer a given volume of liquid from the feed tank into a mix tank. The third embodiment of the portable dosing system uses a pressure transmitter in combination with the internal dimensions of the feed tank and the specific gravity of the liquid to be transferred to determine the appropriate change in pressure required to transfer a desired amount of liquid from the feed tank into a mix tank. Also revealed are methods of operation of the portable dosing system.

The preferred embodiment of each of the embodiments comprises the use of a positive displacement transfer pump as the pump means and a submersible differential pressure transmitter as the pressure transmitter.

### BRIEF DESCRIPTION OF THE SEVERAL VIEWS OF THE DRAWING

FIG. 1 is a view of the first embodiment of the portable dosing system including the pump system, the pressure transmitter, and the control means;

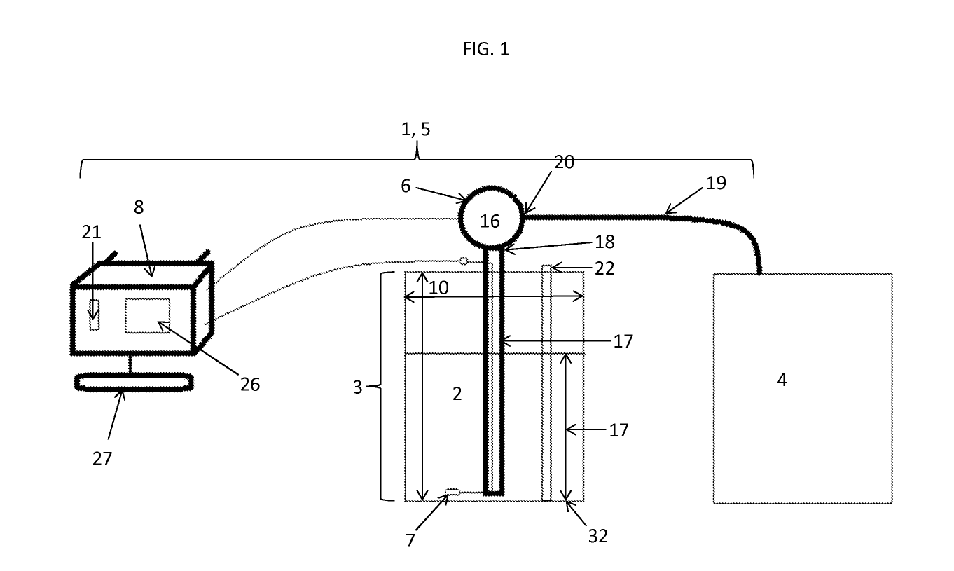

FIG. 2A is a diagram of the logic for the first embodiment of the calculations of the portable dosing system;

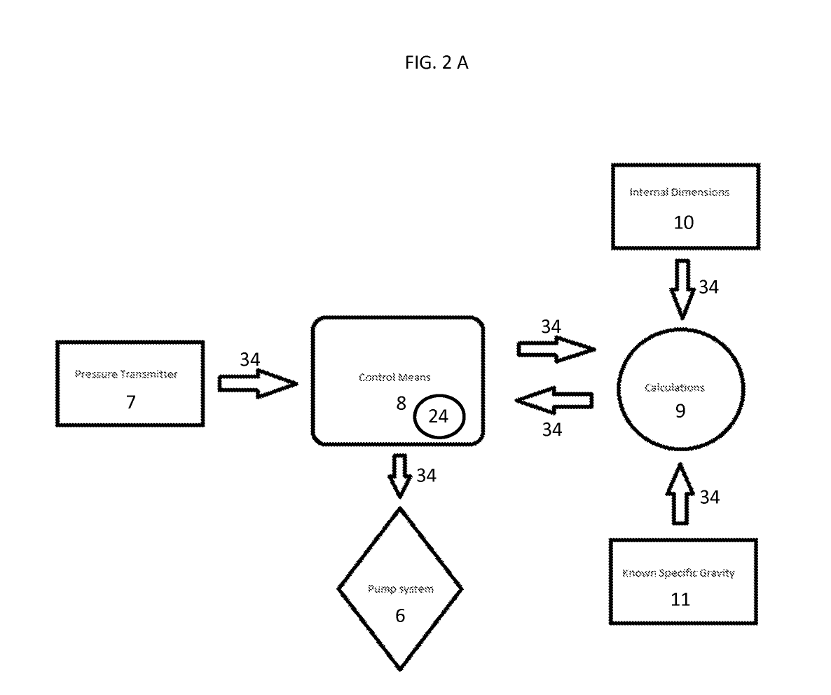

FIG. 2B is a diagram of the logic for the first embodiment of the calibration of the portable dosing system;

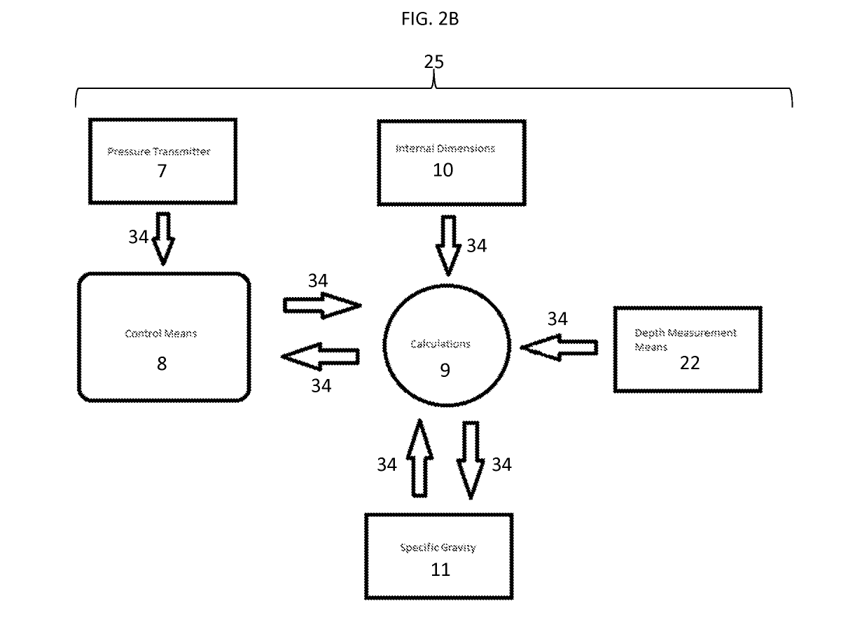

FIG. 3 is a view of the second embodiment of the portable dosing system including the pump system, the pressure transmitter, and the control means;

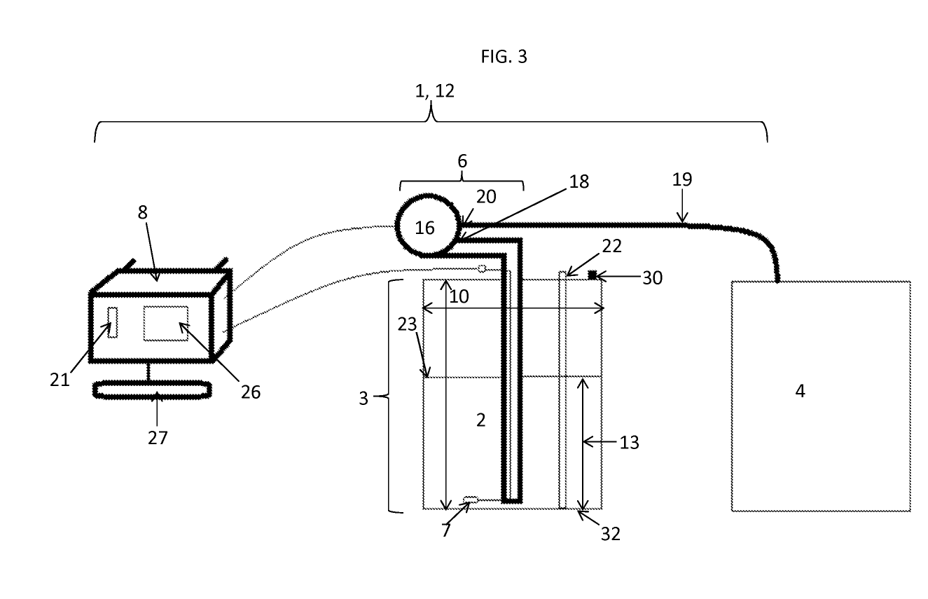

FIG. 4 is a diagram of the logic for the second embodiment of the control system of the second embodiment of the portable dosing system;

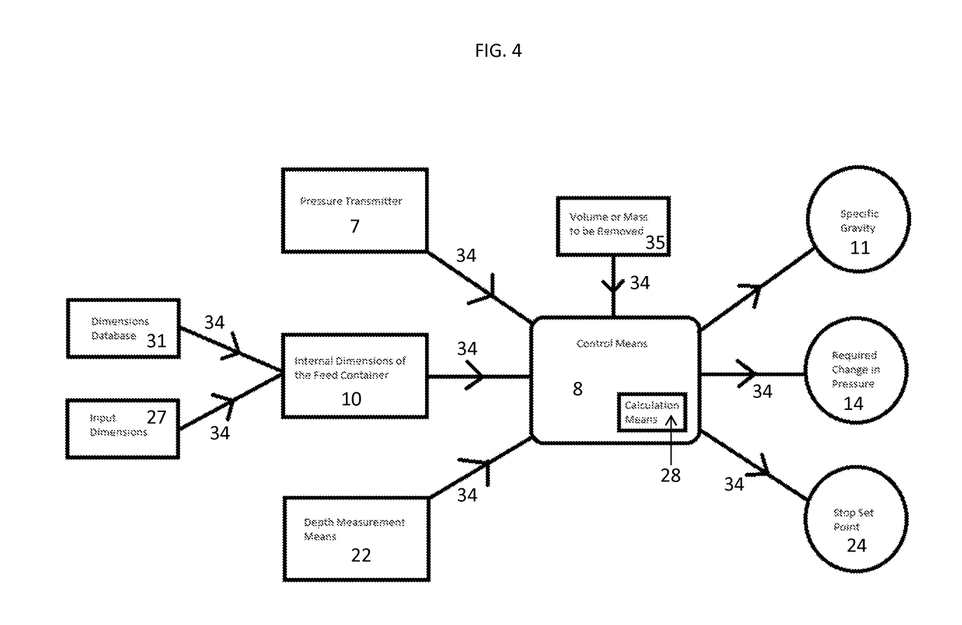

FIG. 5 is a view of the third embodiment of the portable dosing system including the pump system, the pressure transmitter, and the control means; and

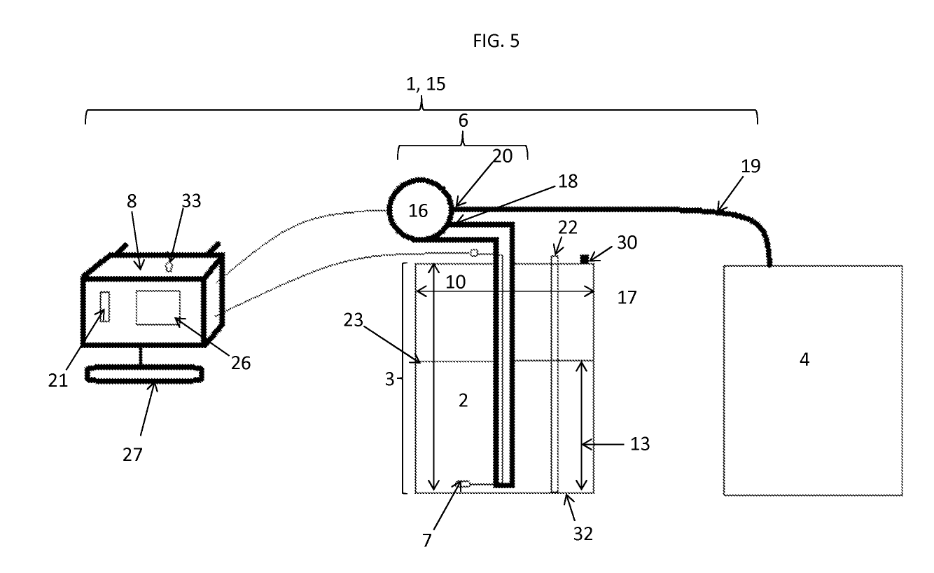

FIG. 6 is a diagram of the logic for the third embodiment of the control system of the third embodiment of the portable dosing system.

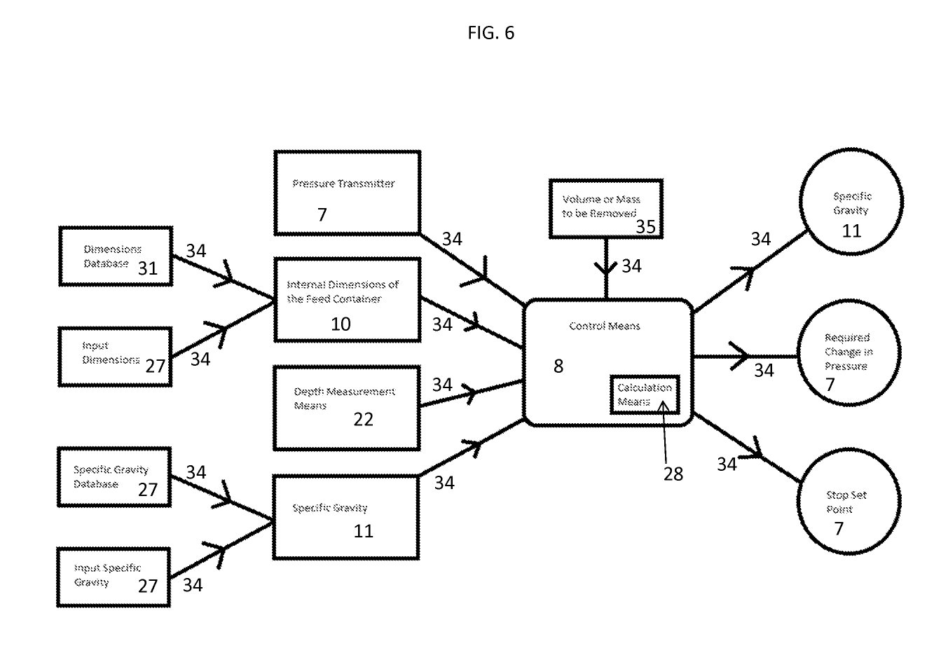

### DETAILED DESCRIPTION OF THE INVENTION

The present disclosure reveals a portable dosing system 1 for the transfer of measured quantities of a liquid 2 from a feed container 3 into a mix container 4, wherein the liquid 2 may be either a liquid 2 or slurry.

The first embodiment 5 the portable dosing system 1 comprises a pump system 6, a pressure transmitter 7 and a control means 8, where calculations 9 are conducted to determine the amount of liquid 2 to be extracted based on the internal dimensions 10 of the feed container 3 and the specific gravity 11 of the liquid 2 to be transferred.

The second embodiment 12 the portable dosing system 1 comprises a pressure transmitter 7 in combination with the depth 13 of the liquid 2 in the feed container 3 and the internal dimensions 10 of the feed container 3 to calculate the specific gravity 11 of the liquid 2 to be transferred in order to then determine the appropriate change in pressure 14 required to transfer a given amount of liquid 2 from the feed container 3 into the mix container 4.

The third embodiment 15 of the portable dosing system 1 comprises a pressure transmitter 7 in combination with the internal dimensions 10 of the feed container 3 and the specific gravity 11 of the liquid 2 to be transferred to determine the appropriate change in pressure 14 required to transfer a desired amount of liquid 2 from the feed container 3 into a mix container 4.

The first embodiment 5 of the portable dosing system 1 for the transfer of measured quantities of a liquid 2 from a feed container 3 into a mix container 4 comprises a pump system 6, a pressure transmitter 7 and a control means 8, where calculations 9 are conducted to determine the amount of liquid 2 to be extracted. The pump system 6 comprises a pump means 16, a withdraw means 17 attached to the suction end 18 of the pump means 16 wherein the withdraw means 17 may comprise a suction hose, a riser pipe or dip tube, and a discharge hose 19 attached to the discharge end 20 of the pump means 16. Said pump means 16 may be a centrifugal pump or a positive displacement pump. The preferred embodiment of the pump means 16 is a diaphragm pump, which is a positive displacement pump. The withdraw means 17 is intended to extend from the pump means 16 into the feed container 3 from which liquid 2 is extracted and it is through the withdraw means 17 the liquid 2 is extracted. The discharge hose 19 facilitates the movement of the liquid 2 from the pump means 16 to the mix container 4.

The pressure transmitter 7 is at least one of an absolute pressure sensor, a gauge pressure sensor, a differential pressure sensor, or a sealed pressure sensor, and is inserted into the feed container 3 so that the pressure transmitter 7 is at the bottom 32 of the feed container 3. The pressure transmitter 7 is also connected to the control means 8. The preferred pressure transmitter 7 is a submersible differential pressure transmitter 7.

The control means 8 receives data 34 from the pressure transmitter 7, displays said data 34 from the pressure transmitter 7 as a signal input scale 21, and controls the pump means 16 such that the pump means 16 is activated and deactivated from the control means 8 and the control means 8 may control the speed of the pump means 16. The control means 8 may further comprise the ability to automatically stop the pump means 16 by means of a set point 24 that can be input into the control means 8 such that, when the pressure reading from the pressure transmitter 7 reaches the value of the set point 24 the pump means 16 stops.

The portable dosing system 1 is calibrated with the use of a depth measurement means 22, the value of the pressure transmitter 7, and the internal dimensions 10 of the feed container 3. The depth measurement means 22 comprises a method of measuring the depth 13 of the liquid 2 in the feed container 3 from the pressure transmitter 7 to the surface 23 of the liquid 2, including the use of a dip stick, a radar level transmitter, an ultrasonic level transmitter, a magnetostrictive level transmitter, a laser level transmitter, a float level, hydrostatic devices, a load cell, magnetic level gauges, or a capacitance transmitter.

A method of operation of the first embodiment 5 of the portable dosing system 1 wherein the portable dosing system 1 transfers a liquid 2 from a feed container 3 to a mix container 4 comprising first, setting up the portable dosing system 1, which includes inserting the withdraw means 17 and pressure transmitter 7 into the feed container 3 and placing a discharge hose 19 into a mix container 4.

Second, calculations 9 are conducted based on the specific gravity 11 of the liquid 2 to be transferred and internal dimensions 10 of the feed container 3, which produces data 34. The data 34 is then used to calibrate the control means 8 and pressure transmitter 7.

Third, the set point 24 for deactivating the pump means 16 may be entered into the control means 8 either as a volume or mass 35.

Fourth, the Pump Means 16 is activated and may be manually or automatically shut off.

A method of calibration 25 of the first embodiment 5 of the portable dosing system 1 wherein the portable dosing system 1 further comprises a depth measurement means 22. The method of calibration 25 comprising first, setting up the portable dosing system 1, which includes inserting the withdraw means 17 and pressure transmitter 7 into the feed container 3 and placing a discharge hose 19 into a mix container 4.

Second, a pressure transmitter 7 reading is obtained.

Third, the actual depth 13 of the liquid 2 in feed container 3 between the pressure transmitter 7 and the surface 23 of the liquid 2 is obtained by the depth measurement means 22.

Fourth, the specific gravity 11 of the liquid 2 is calculated based on the reading from the pressure transmitter 7 and the depth 13 of the liquid 2 obtained by the depth measurement means 22.

Fifth, the signal input scale 21 of the control means 8 is then recalibrated based on the calculated specific gravity 11 of the liquid 2.

The second embodiment 12 of the portable dosing system 1 for the transfer of measured quantities of a liquid 2 from a feed container 3 into a mix container 4 comprises a pump system 6, a pressure transmitter 7, a control means 8, and depth measurement means 22. The pump system 6 comprises a Pump Means 16, a withdraw means 17 attached to the suction end 18 of the Pump Means 16, and a discharge hose 19 attached to the discharge end 20 of the Pump Means 16. The withdraw means 17 may comprise a suction hose, a riser pipe or dip tube. Said Pump Means 16 may be a centrifugal pump or a positive displacement pump. The withdraw means 17 is intended to extend from the Pump Means 16 into the feed container 3 from which the liquid 2 is extracted and it is through the withdraw means 17 the liquid 2 is extracted. The discharge hose 19 facilitates the movement of the liquid 2 from the Pump Means 16 to the mix container 4.

The depth measurement means 22 comprises a method of measuring the depth 13 of the liquid 2 in feed container 3 from the pressure transmitter 7 to the surface 23 of the liquid 2, and the depth measurement means 22 may be a dip stick, a radar level transmitter, an ultrasonic level transmitter, a magnetostrictive level transmitter, a laser level transmitter, a float level, hydrostatic devices, a load cell, magnetic level gauges, a pressure transmitter device, or a capacitance transmitter.

The pressure transmitter 7 is at least one of an absolute pressure sensor, a gauge pressure sensor, a differential pressure sensor, or a sealed pressure sensor, which is inserted into the feed container 3 so that the pressure transmitter 7 is at the bottom 32 of the feed container 3 and the pressure transmitter 7 is connected to the control means 8.

The control means 8 receives data 34 from the pressure transmitter 7 and the depth measurement means 22 and controls the Pump Means 16 such that the Pump Means 16 is activated and deactivated from the control means 8, the rate the Pump Means 16 transfers liquid 2 is controlled by the control means 8, and the control means 8 can deactivate the Pump Means 16 when the pressure transmitter 7 indicates a specific pressure has been obtained based on an input set point 24. The depth measurement means 22 is used in conjunction with the pressure transmitter 7 in order to calculate the specific gravity 11 of the liquid 2 in the feed container 3.

The control means 8 further comprises a readout screen 26, a plurality of input means 27 to input necessary data 34, a pump control means 8, and a calculation means 28 that can take the data 34 input into the control means 8, the pressure detected by the pressure transmitter 7, and the internal dimensions 10 of the feed container 3, in order to calculate the volume of the liquid 2 in the feed container 3 or calculate the required change in pressure 14 of the liquid 2 required in order to dispense the appropriate amount of liquid 2 in to the mix container 4. The readout screen 26 provides the user with information concerning the operation of the portable dosing system 1. The plurality of input means 27 can include a keyboard, key pad, mouse, touch screen, or collection of diodes and control knobs, and allows the user to input data 34 into the control means 8 including but not limited to the type feed container 3 or the internal dimensions 10 of the feed container 3 so that an internal dimensions 10 of the feed container 3 can be known, the depth 13 of the liquid 2 from the pressure transmitter 7 to the surface 23 of the liquid 2, and the quantity of liquid 2 to be extracted. The pump control means 8 activates, deactivates and controls the rate of the Pump Means 16. The calculation means uses the internal dimensions 10 of the feed container 3, the depth 13 of the liquid 2 from the pressure transmitter 7 to the surface 23 of the liquid 2 and the pressure indicated by the pressure transmitter 7 to calculate the specific gravity 11 of the liquid 2, to calculate the change in pressure 14 from the initially identified pressure required to remove the indicated amount of liquid 2 and when the appropriate amount of liquid 2 has been extracted so that the Pump Means 16 is deactivated. The calculation means 28 may also have a dimensions database for types and dimensions of feed containers 3.

The portable dosing system 1 may also comprise a plurality of level sensors 30 to assure the feed container 3 is level before transfer of the liquid 2 to assure accuracy.

A method of operation of the second embodiment 12 of the portable dosing system 1 wherein the portable dosing system 1 transfers a liquid 2 from a feed container 3 to a mix container 4 comprising a pump system 6, a pressure transmitter 7, a control means 8, and a depth measurement means 22, wherein the pump system 6 comprises a Pump Means 16, a withdraw means 17 attached to the suction end 18 of the pump means 16 and a discharge hose 19 attached to the discharge end 20 of the pump means 16. First, the portable dosing system 1 must be set up, which comprises inserting the withdraw means 17 and pressure transmitter 7 into the feed container 3 and placing a discharge hose 19 into a mix container 4.

Second, the necessary data 34 is established within the control means 8. This comprises loading the internal dimensions 10 of the feed container 3, obtaining the depth 13 of the liquid 2 from the surface 23 of the liquid 2 to the pressure transmitter 7 with the use of the depth measurement means 22 and determining the pressure at the pressure transmitter 7. The internal dimensions 10 can be input in to the control means 8, or the internal dimensions 10 can be obtained from a dimensions database 31 contained within the calculation means 28 based on the type of feed container 3. The depth 13 of the liquid 2 can be either input into the control means 8 or obtained from the depth measurement means 22 directly attached to the control means 8. The pressure transmitter 7 is also activated so a continuous pressure reading can be input into the control means 8.

Third, input the desired amount of liquid 2 to be transferred from the feed container 3 to the mix container 4, either as a volume or mass 35. The control means 8 then calculates the specific gravity 11 of the liquid 2 based on the depth 13 of the liquid 2 from the surface 23 of the liquid 2 to the pressure transmitter 7, and calculates the appropriate change in pressure 14 required equal to the amount of liquid 2 to be transferred from the feed container 3 based on the specific gravity 11 of the liquid 2 and the internal dimensions 10 of the feed container 3.

Fourth, the pump means 16 is activated and shuts off automatically once the appropriate change in pressure 14 has been met.

The third embodiment 15 of the portable dosing system 1 for the transfer of measured quantities of a liquid 2 from a feed container 3 into a mix container 4 comprises a pump system 6, a pressure transmitter 7, and a control means 8. The pump system 6 comprises a pump means 16, a withdraw means 17 attached to the suction end 18 of the pump means 16 wherein the withdraw means 17 may comprise a suction hose, a riser pipe or dip tube, and a discharge hose 19 attached to the discharge end 20 of the pump means 16. Said pump means 16 may be a centrifugal pump or a positive displacement pump. The withdraw means 17 is intended to extend from the pump means 16 into the feed container 3 from which the liquid 2 is extracted and it is through the withdraw means 17 the liquid 2 is extracted. The discharge hose 19 facilitates the movement of the liquid 2 from the pump means 16 to the mix container 4.

The pressure transmitter 7 is at least one of an absolute pressure sensor, a gauge pressure sensor, a differential pressure sensor, or a sealed pressure sensor and is inserted into the feed container 3 so that the pressure transmitter 7 is at the bottom 32 of the feed container 3 and the pressure transmitter 7 is connected to the control means 8. The preferred embodiment of the pressure sensor is a differential pressure sensor.

The control means 8 receives data 34 from the pressure transmitter 7, controls the pump means 16 such that the pump means 16 is activated and deactivated from the control means 8 and the control means 8 can deactivate the pump means 16 when the pressure transmitter 7 indicates a pressure has been obtained. The control means 8 is further capable of converting the desired volume or mass 35 of liquid 2 to be transferred into an appropriate amount of pressure reduction of the liquid 2.

The control means 8 further comprises a readout screen, a plurality of input means 27 to input necessary data 34, a pump control means 8, and a calculation means 28 that can take the data 34 input by the user, the pressure detected by the pressure transmitter 7, and the internal dimensions 10 of the feed container 3, in order to calculate the volume of the liquid 2 in the feed container 3 or calculate the required change in pressure 14 of the liquid 2 in order to dispense the appropriate amount of liquid 2 into the mix container 4. The readout screen 26 provides the user with information concerning the operation of the portable dosing system 1. The plurality of input means 27 allows the user to input data 34 into the control means 8 including the type feed container 3 or internal dimensions 10 of the feed container 3 so that an internal dimensions 10 of the feed container 3 can be known, the specific gravity 11 of the liquid 2, and the quantity of liquid 2 to be extracted. The pump control means 8 activates and deactivates the pump means 16. The calculation means 28 uses the internal dimensions 10 of the feed container 3 and the pressure indicated by the pressure transmitter 7 to calculate when the appropriate amount of liquid 2 has been extracted so that the pump means 16 is deactivated. The calculation means 28 may also have a dimensions database 31 for types and dimensions of feed containers 3 or a specific gravity 11 database for the specific gravity 11 of the liquid 2.

The portable dosing system 1 may also comprise a plurality of level sensors 30 to assure the feed container 3 is level before transfer of the liquid 2 to assure accuracy. The portable dosing system 1 may also comprise a plurality of atmospheric pressure sensors 33 to monitor atmospheric pressure.

A method of operation of the third embodiment 15 of the portable dosing system 1 wherein the portable dosing system 1 transfers a liquid 2 from a feed container 3 to a mix container 4 with the use of a pump system 6, a pressure transmitter 7, and a control means 8, wherein the pump system 6 comprises a pump means 16, a withdraw means 17 attached to the suction end 18 of the pump means 16 and a discharge hose 19 attached to the discharge end 20 of the pump means 16. First, the portable dosing system 1 must be set up, which includes inserting the withdraw means 17 and pressure transmitter 7 into the feed container 3 and placing a discharge hose 19 into a mix container 4.

Second, the necessary data 34 is established with the control means 8. This involves determining the internal dimensions 10 of the feed container 3, selecting the specific gravity 11 of the liquid 2 to be pumped and determining the pressure at the pressure transmitter 7. The internal dimensions 10 can be input in to the control means 8, or the internal dimensions 10 can be obtained from a dimensions database 31 contained within the control means 8 based on the type of feed container 3. The specific gravity 11 of the liquid 2 can also be either input into the control means 8 or selected from a specific gravity database 29 within the control means 8. The pressure transmitter 7 is also activated so a continuous pressure reading can be input into the control means 8.

Third, inputting the desired amount of liquid 2 to be transferred from the feed container 3 to the mix container 4, either as a volume or mass 35. The calculation means 28 then calculates the appropriate change in pressure 14 required equal to the amount of liquid 2 to be transferred from the feed container 3.

Fourth, the pump means 16 is activated and shuts off automatically once the appropriate change in pressure 14 has been met.

What is claimed:

1. a portable dosing system for the transfer of measured quantities of a liquid from a feed container into a mix container where calculations are conducted to determine the amount of liquid to be extracted comprising:
a pump system, a pressure transmitter and a control means;
the pump system comprises a pump means, a withdraw means attached to the suction end of the pump means wherein the withdraw means may comprise a suction hose, a riser pipe or dip tube, and a discharge hose attached to the discharge end of the pump means;
Said pump means may be a centrifugal pump or a positive displacement pump;
the withdraw means is intended to extend from the pump means into the feed container from which the liquid is extracted and it is through the withdraw means the liquid is extracted;
the discharge hose facilitates the movement of the liquid from the pump means to the mix container.
the pressure transmitter is at least one of an absolute pressure sensor, a gauge pressure sensor, a differential pressure sensor, or a sealed pressure sensor, is inserted into the feed container so that the pressure transmitter is at the bottom of the feed container and the pressure transmitter is connected to the control means; and
the control means receives data from the pressure transmitter displays said data from the pressure transmitter as a signal input scale, and controls the pump means such that the pump means is activated and deactivated from the control means and the control means may control the speed of the pump means.

2. The portable dosing system of claim 1 wherein the preferred embodiment of the pump means comprises a diaphragm pump, which is a positive displacement pump.

3. The portable dosing system of claim 1 wherein the preferred embodiment of the pressure transmitter is a submersible differential pressure transmitter.

4. The portable dosing system of claim 2 wherein the preferred embodiment of the pressure transmitter is a submersible differential pressure transmitter.

5. The portable dosing system of claim 1 wherein the control means further comprises the ability to automatically stop the pump means by means of a set point can be input into the control means such that, when the pressure reading from the pressure transmitter reaches the set point value the pump means stops.

6. The portable dosing system of claim 5 wherein the preferred embodiment of the pump means comprises a diaphragm pump, which is a positive displacement pump.

7. The portable dosing system of claim 5 wherein the preferred embodiment of the pressure transmitter is a submersible differential pressure transmitter.

8. The portable dosing system of claim 6 wherein the preferred embodiment of the pressure transmitter is a submersible differential pressure transmitter.

9. The portable dosing system of claim 1, 2, 3, 4, 5, 6, 7 or 8 wherein the portable dosing system is calibrated with the use of a depth measurement means, the value of the pressure transmitter and the internal dimensions 10 of the feed container; and
the depth measurement means comprises a method of measuring the depth of the liquid in the feed container from the pressure transmitter to the surface of the liquid.

10. A method of operation of a portable dosing system wherein the portable dosing system transfers a liquid from a feed container to a mix container comprising first, setting up the portable dosing system, which includes inserting the withdraw means and pressure transmitter into the feed container and placing a discharge hose into a mix container;
second, calculations are conducted based on the specific gravity of the liquid to be transferred and internal dimensions of the feed container which produces data. The data is then used to calibrate the control means and pressure transmitter.
third, the set point for deactivating the pump means may be entered into the control means either as a volume or mass.
fourth, the pump means is activated and may be manually or automatically shut off.

11. A method of calibration of a portable dosing system wherein the portable dosing system further comprises a depth measurement means, the method of calibration comprising:
first, setting up the portable dosing system, which includes inserting the withdraw means and pressure transmitter into the feed container and placing a discharge hose into a mix container;
second, an actual pressure transmitter reading is obtained;
third, the actual depth of the liquid in feed container between the pressure transmitter and the surface of the liquid is obtained by the depth measurement means;
fourth, the specific gravity of the liquid is calculated based on the actual reading from the pressure transmitter and the actual depth of the liquid obtained by the depth measurement means; and
fifth, the signal input scale of the control means is then recalibrated based on the actual specific gravity of the liquid.

12. A portable dosing system for the transfer of measured quantities of a liquid from a feed container into a mix container comprising:
a pump system, a pressure transmitter, a control means, and depth measurement means;
the pump system comprises a pump means, a withdraw means attached to the suction end of the pump means, and a discharge hose attached to the discharge end of the pump means;
the withdraw means is intended to extend from the pump means into the feed container from which the liquid is extracted and it is through the withdraw means the liquid is extracted;
the discharge hose facilitates the movement of the liquid from the pump means to the mix container;
the depth measurement means further comprises a method of measuring the depth of the liquid to be removed from the feed tank from the pressure transmitter to the surface of the liquid;
the pressure transmitter is inserted into the feed container so that the pressure transmitter is at the bottom of the feed container and the pressure transmitter is connected to the control means;
the control means receives data from the pressure transmitter, the depth measurement means and controls the pump means such that the pump means is activated and deactivated from the control means and the control means can deactivate the pump means when the pressure transmitter indicates a specific pressure has been obtained into an appropriate amount of pressure reduction of the liquid;
the depth measurement means is used in conjunction with the pressure transmitter in order to calculate the specific gravity of the liquid in the tank;
the control means further comprises a readout screen, a plurality of input means to input necessary data, a pump control means, and a calculation means that can take the data input by the user, the pressure detected by the pressure transmitter, and the internal dimensions of the feed container, in order to calculate the volume of the liquid in the feed container or calculate the required change in pressure of the liquid in order to dispense the appropriate amount of liquid in to the mix container;
the readout screen provides the user with information concerning the operation of the portable dosing system;
the plurality of input means allows the user to input data into the control means including the type feed container of or internal dimensions of the feed container so that an internal dimensions of the feed container can be known, the depth from the pressure transmitter to the surface of the liquid, and the quantity of liquid to be extracted;
the pump control means activates and deactivates the pump means;
the calculation means uses the internal dimensions of the feed container, the depth from the pressure transmitter to the surface of the liquid and the pressure indicated by the pressure transmitter to calculate the specific gravity of the liquid, the change in pressure from the initially identified pressure required to remove the indicated amount of liquid and when the appropriate amount of liquid has been extracted so that the pump means is deactivated; and
the calculation means may also have a dimensions database for types and dimensions of containers.

13. The portable dosing system of claim 12 wherein the preferred embodiment of the pump means comprises a diaphragm pump, which is a positive displacement pump.

14. The portable dosing system of claim 12 wherein the preferred embodiment of the pressure transmitter is a submersible differential pressure transmitter.

15. The portable dosing system of claim 13 wherein the preferred embodiment of the pressure transmitter is a submersible differential pressure transmitter.

16. The portable dosing system of claim 12, 13, 14, or 15 further comprising a plurality of level sensors to assure the feed container is level before transfer of the liquid to assure accuracy.

17. A method of operation of the portable dosing system wherein the portable dosing system transfers a liquid from a feed container to a mix container comprising a pump system, a pressure transmitter, a control means, and depth measurement means, wherein the pump system comprises a pump means, a withdraw means attached to the suction end of the pump means and a discharge hose attached to the discharge end of the pump means;
first, the portable dosing system must be set up, which includes inserting the withdraw means and pressure transmitter into the feed container and placing a discharge hose into a mix container;
Second, the necessary data is established with the control means, which involves determining the internal dimensions of the feed container, obtaining the depth of the liquid from the surface to the pressure transmitter with the use of the depth measurement means and determining the pressure at the pressure transmitter;
the internal dimensions of the feed container can be input in to the control means, or the internal dimensions can be obtained from a dimensions database contained within the control means based on the type of feed container;
the depth of the liquid can be either input into the control means or obtained from the depth measurement means directly attached to the control means;
the pressure transmitter is also activated so a continuous pressure reading can be input into the control means;
third, inputting the desired amount of liquid to be transferred from the feed container to the mix container, either as a volume or mass 35, the control means then calculates the specific gravity of the liquid based on the depth from the surface of the liquid to the pressure transmitter, and calculates the appropriate change in pressure required equal to the amount of liquid to be transferred from the feed container based on the specific gravity of the liquid and the dimensions of the feed container; and
fourth, the pump means is activated and shuts off automatically once the appropriate change in pressure has been met.

18. A portable dosing system for the transfer of measured quantities of a liquid from a feed container into a mix container comprising a pump system, a pressure transmitter, and a control means;
the pump system comprises a pump means, a withdraw means and a discharge hose;
the withdraw means extends from the suction end of the pump means into the feed container;
the discharge hose extends from the discharge end of the pump means to the mix container;
the Pressure transmitter is connected to the control means and extends from the end of the withdraw means that is inserted into the feed container so that the pressure transmitter is at the bottom of the feed container;
the control means receives data from the pressure transmitter, controls the pump means such that the pump is activated and deactivated and the control means can deactivate the pump means when the pressure transmitter indicates a specific pressure has been met;
the control means is further capable of converting the desired volume of liquid to be transferred into an appropriate amount of pressure reduction of the liquid;
the control means further comprises a readout screen, a plurality of input means to input necessary data, a pump control means, and a calculation means that can take the data input by the user, the pressure detected by the pressure transmitter, the dimensions of the container, calculate the volume of the liquid in the feed container and calculate the required change in pressure of the liquid in order to dispense the appropriate amount of liquid;
the readout screen provides the user with information concerning the operation of the portable dosing system;
the plurality of input means allows the user to input data into the control means including the type of or internal dimensions of the feed container so that an internal dimensions of the feed container can be known, the specific gravity of the liquid, and the quantity of liquid to be extracted;
the pump control means activates and deactivates the pump means; and
the calculation means uses the internal dimensions of the feed container and the pressure indicated by the pressure transmitter to calculate when the appropriate amount of liquid has been extracted so that the pump means is deactivated.

19. The portable dosing system of claim 18 wherein the preferred embodiment of the pump means comprises a diaphragm pump, which is a positive displacement pump.

20. The portable dosing system of claim 19 wherein the preferred embodiment of the pressure transmitter is a submersible differential pressure transmitter.

21. The portable dosing system of claim 20 wherein the preferred embodiment of the pressure transmitter is a submersible differential pressure transmitter.

22. The portable dosing system of claim 18 further comprising a plurality of level sensors to assure the feed container is level before transfer of the liquid to assure accurate dimensions.

23. The portable dosing system of claim 22 wherein the preferred embodiment of the pump means comprises a diaphragm pump, which is a positive displacement pump.

24. The portable dosing system of claim 22 wherein the preferred embodiment of the pressure transmitter is a submersible differential pressure transmitter.

25. The portable dosing system of claim 23 wherein the preferred embodiment of the pressure transmitter is a submersible differential pressure transmitter.

26. The portable dosing system of claim 18, 19, 20, 21, 22, 23, 24 or 25 further comprising a plurality of atmospheric pressure sensors to monitor atmospheric pressure, to assure accurate calculations relative the difference between the pressure transmitter and atmospheric pressure.

27. A method of operation of the portable dosing system using a feed container a mix container, a pump system, a pressure transmitter, and a control means, wherein the pump system comprises a pump means, a withdraw means that extends from the suction end of the pump means and a discharge hose that extends from the discharge end of the pump means;
first, the portable dosing system must be set up, which includes inserting the withdraw means and pressure transmitter into a feed container and placing a discharge hose into a mix container;
second, the necessary data is established with the control means including determining the internal dimensions of the feed container, selecting the specific gravity of the liquid to be pumped and determining the pressure at the pressure sensor;
the internal dimensions can be input in to the control means, or the dimensions can be obtained from a database contained within the control means based on the type of feed container;
the specific gravity of the liquid can also be either input into the control means or selected from a database within the control means;
the pressure sensor is also activated so a continuous pressure reading can be input into the control means;
third, inputting the desired amount of liquid to be transferred from the feed container to the mix container, either as a volume of mass;
the control means then calculates the appropriate change in pressure equal to the amount of liquid to be transferred from the feed container; and
fourth, the pump means is activated and shuts off automatically once the appropriate change in pressure has been met.
